(19) United States
(12) Patent Application Publication
(10) Pub. No.: US 2015/0181045 A1
(43) Pub. Date: Jun. 25, 2015

(54) FLEXIBILE EVENT RATING

(71) Applicants: Georg Lang, Ludwigshafen (DE); Artur Kaufmann, Landau (DE)

(72) Inventors: Georg Lang, Ludwigshafen (DE); Artur Kaufmann, Landau (DE)

(73) Assignee: SAP AG, Walldorf (DE)

(21) Appl. No.: 14/139,630

(22) Filed: Dec. 23, 2013

(51) Int. Cl. H04M 15/00; G06Q 40/00

(52) U.S. Cl. CPC H04M 15/41; G06Q 40/12

(57) ABSTRACT

Various embodiments herein each include at least one of systems, methods, and software that operate to provide flexible event data rating solutions. Some such solutions include embodiments that allow an invoicing system to receive and process data from one to many different rating system instances and types procured from multiple vendors or as may have been custom developed. Some such embodiments including multiple rating systems allow application of flexible rules to determine which event transactions are to be rated or rerated by which rating systems and when certain event transactions are to be rated or rerated.

### BACKGROUND INFORMATION

In telecommunications, rating is an activity that determines the cost of chargeable events, such as a cost of service usage, a telephone call, a text message, a data download, a purchase, and the like. Rating may also be performed with regard to other services, such as radio-monitored toll ways, public transit, and the like. Telecommunication access points, turnstiles, and other access points for chargeable events typically generate usage data, in the form of Usage Detail Records (UDR). Examples of UDRs include Call Detail Records (CDR), Event Detail Records (EDR), and Internet Protocol Detail Records (IPDR). UDRs are sent to, or retrieved by, a mediation system that operates between access points and a rating system. The rating system determines the cost of the chargeable events through processing of the UDRs. The cost of the events is then provided to, or retrieved by, an invoicing process.

To date, rating of UDRs and providing rated event data to an invoicing process has been linear in nature. Mediation systems may receive many different types of UDR data. However, mediation systems transform that data into a single format of a single rating system and rated data is output from the single rating system to the invoicing process.

### BRIEF DESCRIPTION OF THE DRAWINGS

FIG. 1 is a block diagram of a system landscape, according to an example embodiment.

FIG. 2 is an illustration of database tables and relations there between, according to an example embodiment.

FIG. 3 is a block flow diagram, according to an example embodiment.

FIG. 4 is a block diagram of a computing device, according to an example embodiment.

### DETAILED DESCRIPTION

Various embodiments herein each include at least one of systems, methods, and software that operate to provide flexible event data rating solutions. Some such solutions include embodiments that allow for an invoicing system, such as the Convergent Invoicing product available from SAP AG of Waldorf, Germany, to receive and process data from one to many different rating system instances and types procured from multiple vendors or as may have been custom developed. An example of such a rating system is the Convergent Charging system, also available form SAP AG. Some such embodiments including multiple rating system allow application of flexible rules to determine which event transactions are to be rated by which rating systems and when certain event transactions are to be rated or rerated.

These solutions are very well adapted to service modern service providers, such as telecommunications service providers, that have seen considerable consolidation in recent years while also expanding their service offerings beyond landline-based telephone service and into wireless voice and data service, wired and wireless internet service, sales of media, and mobile payments, among others. For example, each entity that has been consolidated into a single company may have a legacy rating system for each of several service offerings. Additionally, each service offering may have its own rating system. The various solutions of the illustrated and described embodiments herein bring great flexibility to service providers to generate timely billing information.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

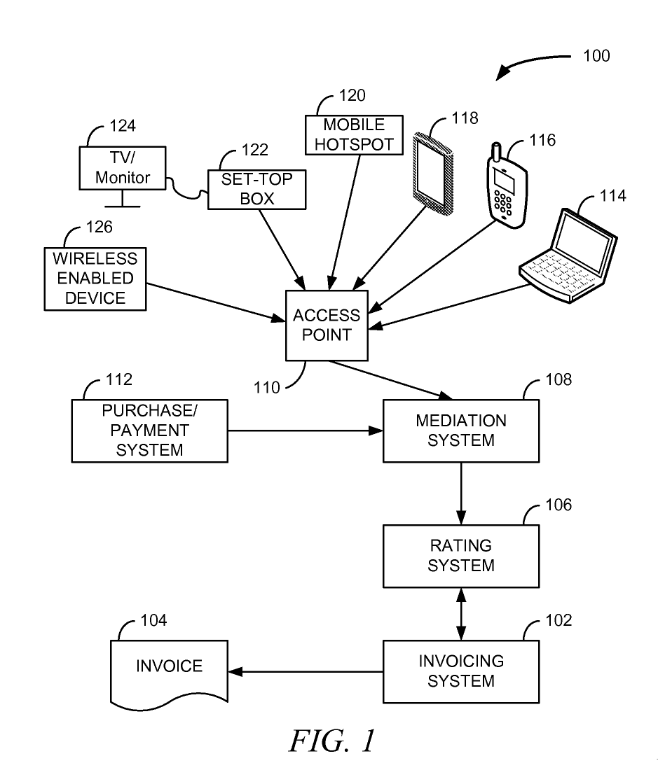

FIG. 1 is a block diagram of a system landscape 100, according to an example embodiment. The system landscape 100 is an example of a computing environment within which some embodiments may be implemented.

The system landscape 100 includes several devices that connect to an access point 110 to access services that generates Usage Detail Records (UDR) based on chargeable access events. The several devices include personal computers 114, smartphones 116, tables 118, mobile hotspots 120, set-top boxes 122, other wireless enabled devices 126, and other devices connectable to an access point 110. Although only a single access point 110 is illustrated, many access points 110 are typically present in various embodiments. The access point 110 may be one or more of a wireless telephone and data access point, a wired or wireless data network access point, a router, a hub, or other network-enabled device capable of generating UDRs.

As one of the several devices utilizes the access point 110, a chargeable event transpires. Details of the event are captured, such as account identifying information, a location calling from, a time and duration of a call, a number called, an amount of data sent, an amount of data received, a number of messages sent and received, a resource accessed, a cost of premium content, cost of physical items purchased, and the like. This captured data is then written to a UDR. The UDR may be stored by the access point 110 and retrieved by a mediation system 108, immediately transmitted via a network to the mediation system 108, written to a network storage location from which the mediation system 108 may retrieve the UDR, and other such arrangements.

The mediation system 108 is a system that converts UDRs to a defined format that can be imported and processed by a rating system 106. The mediation system 108, although referred to as a system, may be module, a process, a web service, or other data processing element, in various embodiments. Additionally, some embodiments may include more than one mediation system 108.

In some embodiments, the mediation system 108 may also receive or retrieve UDRs from one or more other systems, such as a purchase or payment system 112. The purchase or payment system 112, in some embodiments, may be a system of an entity authorized to bill for one or both of services and products via an invoicing system 102 of the system landscape 100. For example, a user may tie one or more other services, such as television services provided by a third party, public transit usage, toll way usage, and the like with an account invoiced or paid through the invoicing system 102.

The mediation system 108 may receive or retrieve UDRs, convert the UDRs into the defined format, and provide the UDRs in the defined format to one or both of a rating system 106 and an invoicing system 102. The mediation system 108, in various embodiments, may transmit the converted UDRs to one or both of the rating system 106 and invoicing system 102, store the converted UDRs for retrieval thereby, store the converted UDRs for a period and then transmit them thereto, and the like.

The rating system 106 performs rating activities with regard to converted UDRs that include representations and details of chargeable events, such as a cost of service usage, a telephone call, a text message, a data download, a purchase, and the like. The rating system 106 includes representations of billing terms for accounts, purchased items and services, and the like, such as may be defined in a customer account contract, terms of service, or pricing of an item or service. In some embodiments, each UDR is processed to identify applicable billing terms, which may be determined based an account identifying data included in the UDR in view of a database storing records associating accounts to contracts and contracts to billing terms. Based on the billing terms, the chargeable event of the UDR is rated and rating data is generated base thereon. The rating data generated from a UDR may be referred to as a consumption item and generally includes account identifying data, data defining an event with regard to the respective account, and a cost element. Note that chargeable events represented in a UDR, when rated and forming a consumption item, may not result in a cost element great than zero (0) or the cost element may be omitted. For example, a contract associated with an account may include unlimited or included amounts of certain usage, such as text messages, data, calling minutes, public transit usage, and the like. In such instances, the rated cost element may be zero. However, in some embodiments, the UDR and consumption item may simply be discarded.

The rating system 106, although illustrated as a single system, may instead be two or more rating systems 106. Each of the plurality of rating systems 106 may be different rating systems, such as may be procured from different software vendors or custom developed. As mentioned above, an example of a rating system 106, in some embodiments, is the Convergent Charging rating system available from SAP AG, of Walldorf, Germany.

The rating system 106, or plurality of rating systems 106, generally include four basic functions: 1) UDR data in; 2) rating; 3) rating data output (e.g., consumption items); and 4) providing the consumption items, and unrated UDRs in some embodiments, to an invoicing system 102. The first basic function, UDR data in generally operates to receive or retrieve converted UDR data from the mediation system 108. The first basic function may then store the UDR data in a queue until the second basic function, rating, reaches the UDR data, or a call of the rating function may be made. In some embodiments, the first basic function may also place a copy of the converted UDR data in a queue of the fourth basic function to provide the copy of the converted UDR data to the invoicing system 102.

The second basic function, rating, operates as discussed above with regard to perform rating activities to generate consumption items. However, the second basic function, rating, may be exposed via an application programming interface (API), a web service, a remote function, and the like. Exposing the second basic function allows the rating to be called by processes of the invoicing system 102. The rating may be called by processes of the invoicing system 102 to rate UDR data that was not rated, was improperly rated and is to be rerated, is to be rerated due to contract or legal changes, or otherwise is to be rerated as may be determined by the invoicing system 102 or as specified by an administrator or service agent.

The invoicing system 102 receives or retrieves one or both of the consumption items and converted UDR data from the rating system 106. In embodiments where there are multiple rating systems 106, the invoicing system receives or retrieves one or both of the consumption items and converted UDR data from the plurality of rating system 106.

Generally, the invoicing system 102, or a larger system such as an Enterprise Resource Planning (ERP) system or Customer Relationship Management (CRM) system of which the invoicing system 102 is a part, includes configuration information logically defining each of the one or more rating system 106 therein. The configuration information also typically includes network connectivity data for use in connecting with each of the one or more rating systems 106 via a network. Additional configuration information may designate a periodic schedule for when data is to be retrieved or received from the rating system(s) 106.

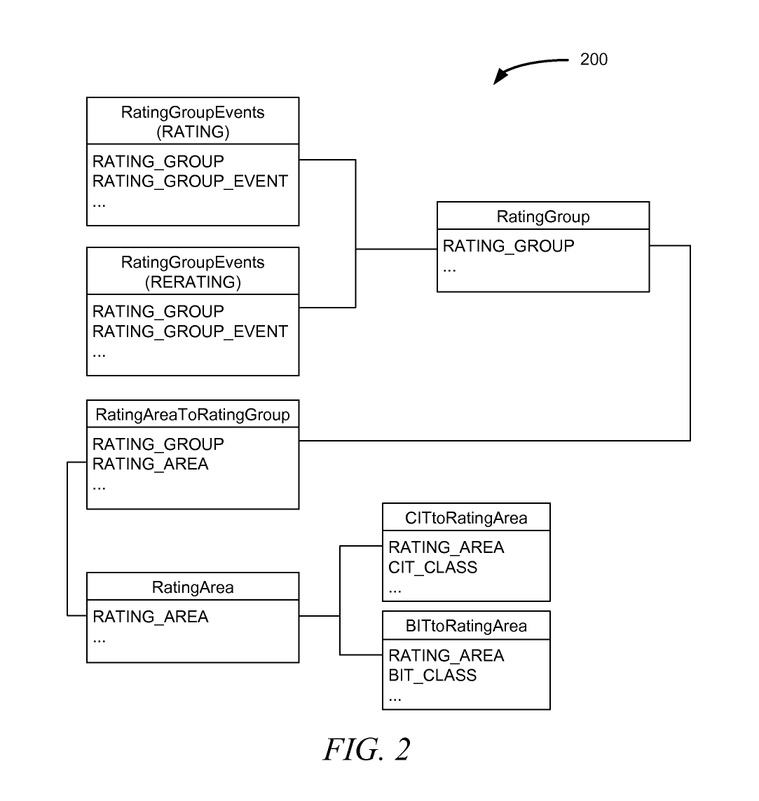

The invoicing system 102 also includes configuration information. The configuration information of the invoicing system 102 identifies consumption item classes and billable item classes of the invoicing system 102 for handling and storing one or both of consumption item and UDR data received from the rating system(s) 106 and billable items generated therefrom. Note that a consumption item, once billed or processed for billing, becomes a billable item and may be stored distinctly and with the same, less, or additional data based on the processing of the particular embodiment. The configuration information of the invoicing system 102 also includes data defining relations between received consumption items and a pricing structure, referred to as a rating area, such as may be defined in customer contracts, customer agreements, and other pricing structures. The configuration information of the invoicing system 102 additionally includes information associating one or more rating areas to each to one or more rating groups. An illustration of this configuration information and relations there between, according to some embodiment, is included in the FIG. 2 illustration of database tables 200 and relations.

Continuing with FIG. 2, also illustrated are associations of rating group events and rerating rating group events. This configuration information assigns executable code, modules, or services to a rating group. In the event consumption item, billable item, or UDR data stored of a rating group is to be rated or rerated after receipt by the invoicing system 102, the appropriate rating or rerating group events are identified based on data associations as represented between the database tables of FIG. 2. In some embodiments, the rating and rerating group events provide processing branches that may be customized to perform processing during rating and rerating and define technical data processing activities that will be carried out during rating and rerating of consumption and billable items. These technical data processing activities may include calls to one or more functions of objects, methods, processes, other systems, web services, and the like. These calls may be added to the rating and rerating events that are to be performed in certain sequences, such as before, in concert with, and after rating or rerating data processing activities are performed, such as through one or more calls of the rating basic functions of one or more rating systems 106.

For example, in some embodiments, when a billable item is to be rerated, there may be three defined events: 1) before rerating; 2) the rerating itself; and 3) after rerating. For the before rerating event, the event may include a function call to lock a billable item class instance or data record that stores the billable item to be rerated. Next, the rerating may be performed by retrieving data of the billable item from the billable item class instance or data record that is to be rerated and calling a rating function of the proper rating system 106 by including at least a portion of the retrieved data in the call. In response thereto, the rating system 106 will provide the rerated data in the form of a consumption item. The after rerating event will the received consumption item data to generate billable item data, update the billable item class instance or data record, and unlock the billable item class instance or data record. The same or similar events may also be defined for rating of rating group events. Note that when a rating system 106 is to be called, the proper rating system 106 to call is identifiable through data stored in the database tables 200 of FIG. 2 as the rating group of the called events as stored in the RatingGroup table stores such data. Additionally, when calling the rating function of the rating system 106, if an identifier of a contract, customer agreement, or the like is need to determine how the billable item or consumption item is to be rated, that data can be obtained from the RatingArea table which stores such data.

Returning now to FIG. 1, once all data that is in need of rating or rerating has been processed, data can be output by the invoicing system 102 in form of an invoice to be sent to subscriber or other customer. However, in other embodiments, the invoicing system 102 may be configured to generate daily usage reports with regard to billing, such as a customer of a wireless telephone and data company may desire to see prior to the end of a billing cycle to monitor usage. In such instances, the billable item data may be stored as a web page view or as data in billable item class instances or data records stored in a database that may be retrieved for presentation in a webpage or app view or as may be provide via an interactive voice response system.

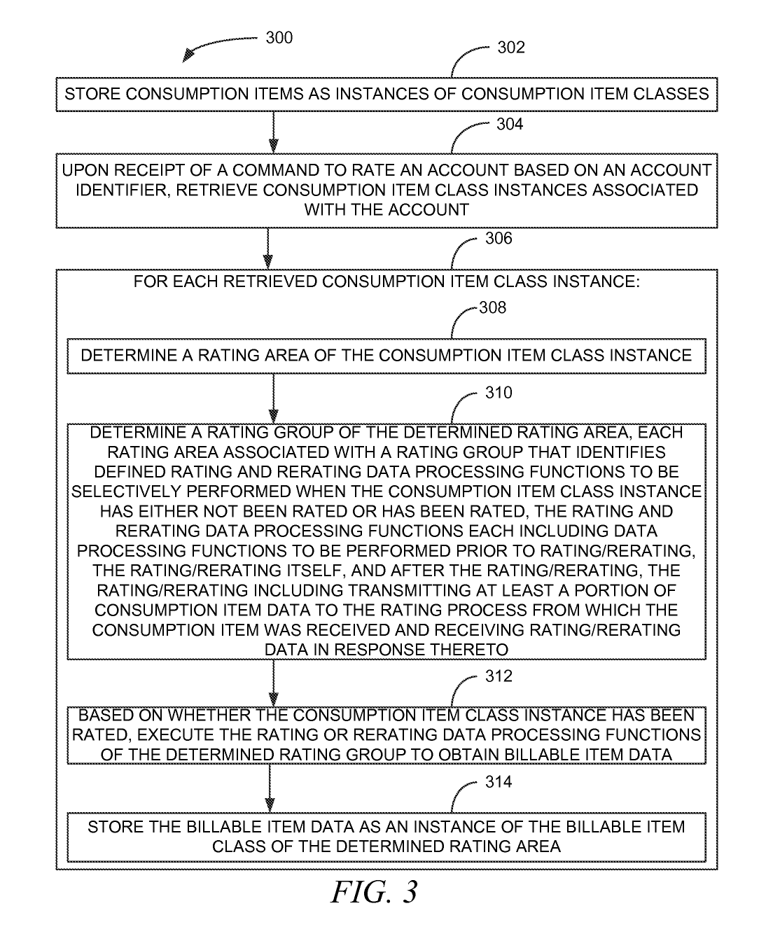

FIG. 3 is a block flow diagram, according to an example embodiment. The method 300 is an example of a method that may be performed by an invoicing system or a module of another data processing system that is involved in a billing process.

The example method 300 includes storing 302 consumption items as instances of consumption item classes. Each consumption item typically includes an account identifier and data defining an event with regard to the respective account. In some embodiments, the data defining the event included in each consumption item defines a billable event, such as a placed call, with regard to the identified account and includes a billable amount and billable event detail.

The consumption items, in some embodiments, are each stored 302 as a consumption item class instance determined based upon a rating process from which the consumption item was received. As such, a number of consumption item classes that exists within a system implementing the method 300 will typically be at least equal to a number of rating processes, or systems, from which the system is configured to receive consumption item data. In some embodiments, the instances of the consumption item classes are each stored as at least one record in at least one database table. In other embodiments, the instances of consumption item classes may each be stored as data files, as rows of one or more data files, and other data structures.

The method 300, upon receipt of a command to rate an account based on an account identifier, may then retrieve 304 consumption item class instances associated with the account. A command to rate an account may be received as part of a billing cycle closing process to generate an invoice with regard to customer accounts. In other embodiments, the command may be received upon an attempt of a wireless service subscribe to initiate a call or at the end of a call, such as when the wireless service subscriber is on a prepay customer. In some other instances, the command may be received in response to a customer requesting account balance information via a web page, a mobile device app, or via an interactive voice response system.

In another embodiment, each consumption item class instance may include date data of a date on which the event occurred, which may be an actual date of the event or a date on which the consumption data was received by an invoicing system or module performing the method. The rating command in such instances may be received with a date element identifying consumption items to be rated, such as past 30 days, current month, a date range, since a last bill, and the like. In such embodiments, the consumption item class instances may be retrieved as a function of this date element included with the received command.

Regardless of why or how the command to rate an account is received, for each 306 retrieved 304 consumption item class instance, the method 300 may first determine 308 a rating area of the consumption item class instance. This may be determined 308, in some embodiments, by querying one or more database tables, such as is illustrated and described with regard to FIG. 2, that store configuration data. For example, in the stored data, each consumption item class may be associated with a rating area that identifies a rating process from which consumption items stored as consumption item class instances are received. Similarly, the stored data may also include a billable item class associated with the rating area and an instance of such a billable item class stores billable item data output by rating and rerating data processing functions.

Additionally, the method 300 includes determining 310 a rating group of the determined 308 rating area. Again, this may be determined 310 in some embodiments by querying one or more of the database tables illustrated and described with regard to FIG. 2 that store configuration data. For example, in the stored data, each rating area is associated with a rating group that identifies defined rating and rerating data processing functions, or events, to be selectively performed when the consumption item class instance has either not been rated or has been rated. In such embodiments, the rating and rerating data processing functions may each include data processing functions to be performed prior to rating/rerating, the rating/rerating itself, and after the rating/rerating. The rating/rerating may include transmitting at least a portion of consumption item data to the rating process from which the consumption item was received and receiving rating/rerating data in response thereto.

The method 300 also includes, based on a determination of whether the consumption item class instance has been previously rated, executing 312 the rating or rerating data processing functions of the determined rating group to obtain billable item data. The method 300 may then store 314 the billable item data as an instance of the billable item class of the determined rating area.

As mentioned above, the stored data may also include billable item class instance that store billable item data output by rating and rerating data processing functions. Data of the billable item class instances is consumed by an invoicing process that is executable to generate an invoice with regard to accounts identified in consumption item and billable item class instances. In such embodiments, the command to rate an account based on an account identifier may be received from such an invoicing process.

In some embodiments, upon receipt of the command to rate an account based on an account identifier, the method 300 further includes retrieving billable item class instances associated with the account. In such embodiments, for each retrieved billable item class instance, the method 300 includes determining a rating area of the billable item class instance and determining a rating group of the determined rating area. Such determinations may be made, for example, through queries of database tables 200 as illustrated in FIG. 2. Subsequently, based on whether the billable item class instance has been rated, such embodiments may then execute the rating or rerating data processing functions of the determined rating group to obtain billable item data and the billable item class instance may be updated with the billable item data.

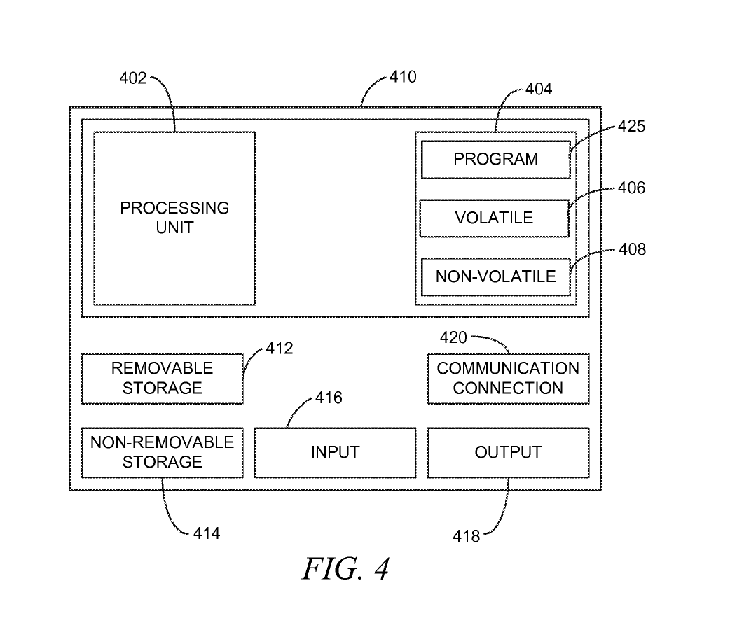

FIG. 4 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Although the example computing device is illustrated and described as computer 410, the computing device may be in different forms in different embodiments. For example, the computing device may instead be a smartphone, a tablet, or other computing device including the same or similar elements as illustrated and described with regard to FIG. 4. Further, although the various data storage elements are illustrated as part of the computer 410, the storage may also or alternatively include cloud-based storage accessible via a network, such as the Internet.

Returning to the computer 410, memory 404 may include volatile memory 406 and non-volatile memory 408. Computer 410 may include—or have access to a computing environment that includes a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 410 may include or have access to a computing environment that includes input 416, output 418, and a communication connection 420. The input 416 may include one or more of a touchscreen, touchpad, mouse, keyboard, camera, and other input devices. The computer may operate in a networked environment using a communication connection 420 to connect to one or more remote computers, such as database servers, web servers, and other computing device. An example remote computer may include a personal computer (PC), server, router, network PC, a peer device or other common network node, or the like. The communication connection 420 may be a network interface device such as one or both of an Ethernet card and a wireless card or circuit that may be connected to a network. The network may include one or more of a Local Area Network (LAN), a Wide Area Network (WAN), the Internet, and other networks.

Computer-readable instructions stored on a computer-readable medium are executable by the processing unit 402 of the computer 410. A hard drive (magnetic disk or solid state), CD-ROM, and RAM are some examples of articles including a non-transitory computer-readable medium. For example, various computer programs 425 or apps, such as one or more applications and modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
storing consumption items as instances of consumption item classes, each consumption item including an account identifier, data defining an event with regard to the respective account, and stored as a consumption item class instance determined based upon a rating process from which the consumption item was received;
upon receipt of a command to rate an account based on an account identifier, retrieving consumption item class instances associated with the account;
for each retrieved consumption item class instance:
determining a rating area of the consumption item class instance, each consumption item class associated with a rating area that identifies a rating process from which consumption items stored as consumption item class instances are received and a billable item class, an instance of which billable item data output by rating and rerating data processing functions is stored;
determining a rating group of the determined rating area, each rating area associated with a rating group that identifies defined rating and rerating data processing functions to be selectively performed when the consumption item class instance has either not been rated or has been rated, the rating and rerating data processing functions each including data processing functions to be performed prior to rating/rerating, the rating/rerating itself, and after the rating/rerating, the rating/rerating including transmitting at least a portion of consumption item data to the rating process from which the consumption item was received and receiving rating/rerating data in response thereto;
based on whether the consumption item class instance has been rated, executing the rating or rerating data processing functions of the determined rating group to obtain billable item data; and
storing the billable item data as an instance of the billable item class of the determined rating area.

2. The method of claim 1, wherein the instances of the consumption item classes are each stored as at least one record in at least one database table.

3. The method of claim 1, wherein data defining the event included in each consumption item defines a billable event with regard to the identified account and includes a billable amount and billable event detail.

4. The method of claim 1, wherein:
each consumption item class instance includes date data of a date on which the event occurred;
the command to rate the account is received with a date element identifying consumption items to be rated; and
the consumption item class instances are retrieved as a function of the date element.

5. The method of claim 1, wherein:
billable item data is data consumed by an invoicing process that is executable to generate an invoice with regard to accounts identified in consumption item and billable item class instances; and
the command to rate the account based on the account identifier is received from the invoicing process.

6. The method of claim 1, wherein upon receipt of the command to rate an account based on an account identifier, the method further includes:
retrieving billable item class instances associated with the account;
for each retrieved billable item class instance:
determining a rating area of the billable item class instance;
determining a rating group of the determined rating area;
based on whether the billable item class instance has been rated, executing the rating or rerating data processing functions of the determined rating group to obtain billable item data; and
updating the billable item class instance with the billable item data.

7. The method of claim 1, wherein stored consumption item class instances associated with at least one account are of at least two consumption item classes, the consumption items stored in instances of the at least two consumption item classes received from a number of different rating processes equal to the number of the at least two consumption item classes.

8. A non-transitory computer-readable medium, with instructions stored thereon, which when executed by at least one processor of a computing device, causes the computing device to:
store consumption items as instances of consumption item classes, each consumption item including an account identifier, data defining an event with regard to the respective account, and stored as a consumption item class instance determined based upon a rating process from which the consumption item was received;
upon receipt of a command to rate an account based on an account identifier, retrieve consumption item class instances associated with the account;
for each retrieved consumption item class instance:
determine a rating area of the consumption item class instance, each consumption item class associated with a rating area that identifies a rating process from which consumption items stored as consumption item class instances are received and a billable item class, an instance of which billable item data output by rating and rerating data processing functions is stored;
determine a rating group of the determined rating area, each rating area associated with a rating group that identifies defined rating and rerating data processing functions to be selectively performed when the consumption item class instance has either not been rated or has been rated, the rating and rerating data processing functions each including data processing functions to be performed prior to rating/rerating, the rating/rerating itself, and after the rating/rerating, the rating/rerating including transmitting at least a portion of consumption item data to the rating process from which the consumption item was received and receiving rating/rerating data in response thereto;
based on whether the consumption item class instance has been rated, execute the rating or rerating data processing functions of the determined rating group to obtain billable item data; and
store the billable item data as an instance of the billable item class of the determined rating area.

9. The non-transitory computer-readable medium of claim 8, wherein the instances of the consumption item classes are each stored as at least one record in at least one database table.

10. The non-transitory computer-readable medium of claim 8, wherein data defining the event included in each consumption item defines a billable event with regard to the identified account and includes a billable amount and billable event detail.

11. The non-transitory computer-readable medium of claim 8, wherein:
each consumption item class instance includes date data of a date on which the event occurred;
the command to rate the account is received with a date element identifying consumption items to be rated; and
the consumption item class instances are retrieved as a function of the date element.

12. The non-transitory computer-readable medium of claim 8, wherein:
billable item data is data consumed by an invoicing process that is executable to generate an invoice with regard to accounts identified in consumption item and billable item class instances; and
the command to rate the account based on the account identifier is received from the invoicing process.

13. The non-transitory computer-readable medium of claim 8, wherein upon receipt of the command to rate an account based on an account identifier, the instructions are further executable to cause the computing device to:
retrieve billable item class instances associated with the account;
for each retrieved billable item class instance:
determine a rating area of the billable item class instance;
determine a rating group of the determined rating area;
based on whether the billable item class instance has been rated, execute the rating or rerating data processing functions of the determined rating group to obtain billable item data; and
update the billable item class instance with the billable item data.

14. The non-transitory computer-readable medium of claim 8, wherein stored consumption item class instances associated with at least one account are of at least two consumption item classes, the consumption items stored in instances of the at least two consumption item classes received from a number of different rating processes equal to the number of the at least two consumption item classes.

15. A system comprising:
at least one processor;
at least one memory;
at least one network interface; and
an instruction set accessible in the memory and executable by the at least one processor to:
store, in the at least one memory, consumption items as instances of consumption item classes, each consumption item including an account identifier, data defining an event with regard to the respective account, and stored as a consumption item class instance determined based upon a rating process from which the consumption item was received, the rating process callable via the at least one network interface;
upon receipt of a command to rate an account based on an account identifier, retrieve consumption item class instances associated with the account;
for each retrieved consumption item class instance:
determine a rating area of the consumption item class instance, each consumption item class associated with a rating area that identifies a rating process from which consumption items stored as consumption item class instances are received and a billable item class, an instance of which billable item data output by rating and rerating data processing functions is stored;
determine a rating group of the determined rating area, each rating area associated with a rating group that identifies defined rating and rerating data processing functions to be selectively performed when the consumption item class instance has either not been rated or has been rated, the rating and rerating data processing functions each including data processing functions to be performed prior to rating/rerating, the rating/rerating itself, and after the rating/rerating, the rating/rerating including transmitting at least a portion of consumption item data to the rating process from which the consumption item was received and receiving rating/rerating data in response thereto;
based on whether the consumption item class instance has been rated, execute the rating or rerating data processing functions of the determined rating group to obtain billable item data; and
store, in the at least one memory, the billable item data as an instance of the billable item class of the determined rating area.

16. The system of claim 15, wherein data defining the event included in each consumption item defines a billable event with regard to the identified account and includes a billable amount and billable event detail.

17. The system of claim 15, wherein:
each consumption item class instance includes date data of a date on which the event occurred;
the command to rate the account is received with a date element identifying consumption items to be rated; and
the consumption item class instances are retrieved as a function of the date element.

18. The system of claim 15, wherein:
billable item data is data consumed by an invoicing process that is executable to generate an invoice with regard to accounts identified in consumption item and billable item class instances; and
the command to rate the account based on the account identifier is received from the invoicing process.

19. The system of claim 15, wherein upon receipt of the command to rate an account based on an account identifier, the instruction set is further executable to:
retrieve billable item class instances associated with the account;
for each retrieved billable item class instance:
determine a rating area of the billable item class instance;
determine a rating group of the determined rating area;
based on whether the billable item class instance has been rated, execute the rating or rerating data processing functions of the determined rating group to obtain billable item data; and
update the billable item class instance with the billable item data.

20. The system of claim 15, wherein stored consumption item class instances associated with at least one account are of at least two consumption item classes, the consumption items stored in instances of the at least two consumption item classes received from a number of different rating processes equal to the number of the at least two consumption item classes.
